(19) United States
(12) Patent Application Publication
(10) Pub. No.: US 2026/0339617 A1
(43) Pub. Date: Oct. 29, 2026

(54) STANDARDS COMPLIANT AUTOMATION AND CONFIGURATION MANAGEMENT

(71) Applicant: Red Hat, Inc., Raleigh, NC (US)

(72) Inventors: Leigh Griffin, Waterford (IE); Pierre-Yves Chibon, Puteaux (FR)

(21) Appl. No.: 19/190,520

(22) Filed: Apr. 25, 2025

(51) Int. Cl. G06F 8/30

(52) U.S. Cl. CPC G06F 8/30

(57) ABSTRACT

Embodiments of the present disclosure provide techniques for using an automation controller to analyze modifications to be implemented on an application to determine whether such modifications are standards compliant. An automation controller may receive a modification to be implemented on an application, wherein the automation controller is modified to include compliance logic for verifying compliance with a safety standard. The automation controller may analyze the modification using the compliance logic to determine whether the modification is compliant with the safety standard. In response to determining that the modification is compliant with the safety standard, the automation controller may implement the modification on the application. If the automation controller determines that the modification is not compliant with the safety standard, it may prevent implementation of the modification on the application.

### TECHNICAL FIELD

The present disclosure relates generally to software technology, and more particularly, to systems and methods of determining whether modifications to be implemented on an application(s) will impact the application(s)′ compliance with a safety standard.

### BACKGROUND

Industries such as the automotive, government, aviation, and healthcare industries have a strong requirement for functional and other types of safety. For example, modern vehicles (e.g., automotive vehicles, marine vehicles, railed vehicles, aircraft vehicles, etc.) include computing systems that can execute one or more applications (e.g., software, computer code) to provide a variety of different critical services for managing the critical operations of the vehicle. Applications that execute on a vehicle's computing system may be either safety-related or non-safety-related applications (sometimes referred to as a “user applications”). An automotive safety-related application might control the movement (e.g., acceleration, velocity, breaking, and/or steering) of the vehicle, while a user application might control the air conditioning in the cabin of the vehicle or provide navigational directions for the driver. Automotive safety-related applications, as well as applications in many other contexts, may require classification as standards compliant to be implemented. Standards compliance may have industry specific synonyms such as functional safety (FUSA) compliance.

An application that is classified as standards compliant is backed by a contractual agreement/engagement from the vendor of the application that the application will follow certain best practices/policies to ensure that the application behaves in a documented way and that such behavior will be consistent over time and consistent through changes to the code of the application. An application must comply with numerous stringent rules to ensure that it is standards compliant and each industry and/or vendor may have its own set of rules that applications must comply with to be standards compliant. For example, automotive safety-related applications may need to meet a set of rules embodied by an appropriate standard such as the ISO 26262 standard. In another example, government websites may have stringent data privacy requirements embodied by standards such as the California Consumer Privacy Act (CCPA) and the General Data Protection Regulation (GDPR). Any application running on a government IT system must meet the rules embodied by one or more of these standards in order to be classified as standards compliant.

Automation controllers are suites of software tools that can be used to automate a variety of operations related to computing resources, including configuration management, application deployment, cloud provisioning, task execution, network automation, and multi-node orchestration. In the past, such operations would generally be performed by a human operator that logs into a computing system to manually perform tasks. As computing infrastructure increases in size and complexity, the manual performance of these tasks may become time consuming and error prone. The automation provided by automation controllers can be used to orchestrate changes over thousands of devices while reducing the level of human involvement in provisioning, installing, configuring, and maintaining computing resources. One example of such an automation controller is the Red Hat™ Ansible™ Automation Platform.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example system, according to some embodiments of the present disclosure.

FIG. 2A is a block diagram of the system illustrated in FIG. 1, illustrating standards compliance analysis of modifications to be implemented on an application(s), according to some embodiments of the present disclosure.

FIG. 2B is a block diagram of the system illustrated in FIG. 1, illustrating standards compliance analysis of modifications to be implemented on an application(s), according to some embodiments of the present disclosure.

FIG. 3 is a detailed block diagram of the system illustrated in FIG. 1, illustrating the process of identifying an application(s) that have become standard non-compliant and rolling such applications back to a previously compliant state, according to some embodiments of the present disclosure.

FIG. 4 is a flow diagram depicting a method of analyzing modifications to be implemented on applications to determine whether such modifications will render the applications non-standards compliant, according to some embodiments of the present disclosure.

FIG. 5 is a block diagram of an example computing device that may perform one or more of the operations described herein, in accordance with some embodiments.

### DETAILED DESCRIPTION

Although an application may pass numerous stringent tests to ensure that it is standards compliant, updates to an application that has already been certified as standards compliant can change the functionality of the application such that it is no longer standards compliant. Examples of such updates include peer to peer updates, a hot patch or any other update mechanism that fundamentally changes the source code of an application that has already been certified as standards compliant.

As the complexity and diversity of software systems increase, efficient and reliable configuration management becomes a challenge. This is particularly true in industries such as automotive where fleet management requires that each of a plurality of cars have the same application configurations and profiles. Given the large number of different applications that must each be standards compliant and the frequency with which applications are updated/modified, ensuring that all of the applications on even a single device are standards compliant is a computationally intensive task. In addition, the set of tests that must be passed to ensure standards compliance for a single application can be large. If, for each application, the set of tests must be executed each time the application is updated, this would result in a fairly continuous and large-scale computational demand. The use of an automation controller can alleviate these concerns, however any external tool that interfaces with a device implicates significant standards compliance risks, as a misconfiguration can invalidate the standards compliance of an application.

Aspects of the present disclosure address the above-noted and other deficiencies by providing techniques for using an automation controller to analyze modifications to be implemented on an application to determine whether such modifications are standards compliant. By shifting standards compliance mechanisms to an automation controller (i.e., configuration management system), embodiments of the present disclosure ensure the interoperability of the automation controller still adheres to the standards compliance requirements of the target device.

An automation controller may receive a modification to be implemented on an application, wherein the automation controller is modified to include compliance logic for verifying compliance with a safety standard. The automation controller may analyze the modification using the compliance logic to determine whether the modification is compliant with the safety standard. Each action associated with implementing the modification may be included in an automation script, along with a corresponding rule from the safety standard for determining if the action is standards compliant. In response to determining that the modification is compliant with the safety standard, the automation controller may implement the modification on the application. If the automation controller determines that the modification is not compliant with the safety standard, it may prevent implementation of the modification on the application.

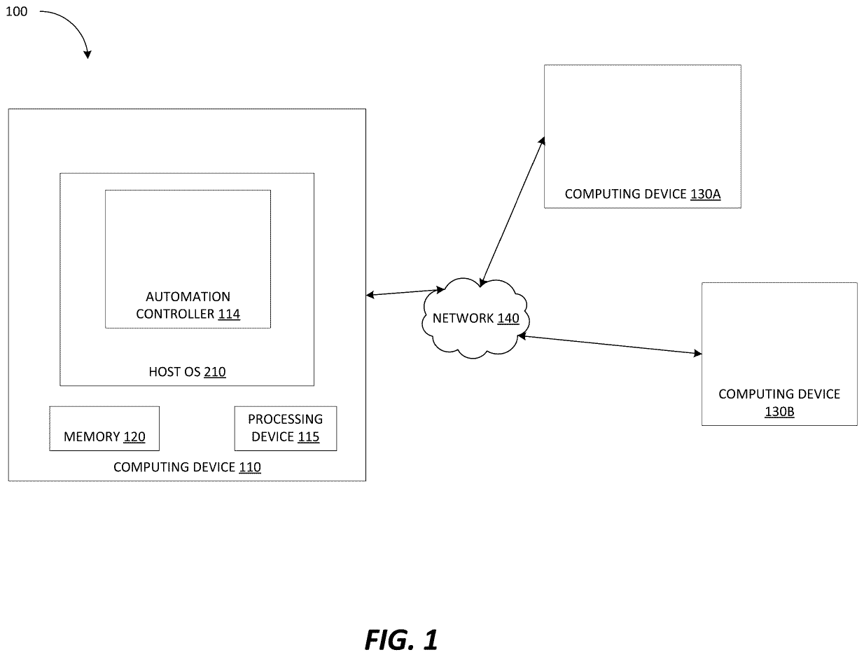

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110 and computing devices 130.

Each computing device may include hardware such as processing device 115 (e.g., processors, central processing units (CPUs), memory 120 (e.g., random access memory (RAM), storage devices (e.g., hard-disk drive (HDD), solid-state drive (SSD), etc.)), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 of computing device 110, as discussed in more detail below. The host OS of a computing device may manage the execution of other components (e.g., software, applications, etc.) and/or may manage access to the hardware (e.g., processors, memory, storage devices etc.) of the computing device.

Each computing device 130 may run one or more applications 131. The functionality of the applications 131 may vary based on the context that the system 100 is implemented in. For example, if the system 100 is implemented in a healthcare context, the applications 131 may be healthcare applications such as medical billing applications and patient health monitoring applications. The embodiments of the present disclosure are described using the non-limiting example of a fleet of vehicles as the context the system 100 is implemented in, where each computing device 130 of the system 100 may correspond to a vehicle that executes one or more applications 131. Each of the applications 131 may correspond to a safety-related automotive application such as braking and collision avoidance, that must be standards compliant (referred to as FUSA compliant in the examples described herein). However, it should be noted that standards compliance may refer to compliance with any appropriate standard.

The computing device 110 may include an automation controller 114 which may comprise an automation tool such as Red Hat Ansible™, which is an open-source automation tool that allows users to automate the configuration, management, and deployment of systems and applications such as a cluster of worker nodes. The automation controller 114 may allow users to define their infrastructure as code using any appropriate language e.g., Yet Another Markup Language (YAML), which is a declarative language. The automation controller 114 may use a client-server architecture, where a central machine, known e.g., as the control node (computing device 110 in the example of FIG. 1), manages and orchestrates the automation process. The control node connects to target nodes (computing devices 130 in the example of FIG. 1) over Secure Shell protocol (SSH) or other protocols and executes tasks that are included in “playbooks.” A playbook may be a script that defines a set of tasks and configurations to be executed on remote systems. A playbook (also referred to herein as an automation script) includes one or more plays, and each play includes a set of tasks. Plays are a collection of tasks that are executed together on a group of hosts or a set of hosts defined by patterns. Tasks within a playbook define actions to be performed on the target devices, such as installing packages, copying files, updating software, starting or stopping services, executing commands, configuring network settings, etc. Although discussed herein as an automation tool, the automation controller 114 could also be implemented as an infrastructure as code (IaC) tool such as Terraform or Otter, for example.

The automation controller 114 may be coupled to a database of automation data (not shown) that can be used to create a playbook. For example, the automation data may include an inventory of target nodes, scripts and/or code modules to be executed on the target nodes, and other information. The playbook may be initiated manually by the user or in accordance with a schedule defined by the user. The playbook may be configured to perform any of a variety of automated tasks such as e.g., executing software updates (e.g., patches) and implementing configuration changes for applications 131 and/or computing devices 130, as discussed in further detail herein. Those of ordinary skill in the art will recognize a wide variety of additional applications for the techniques described herein.

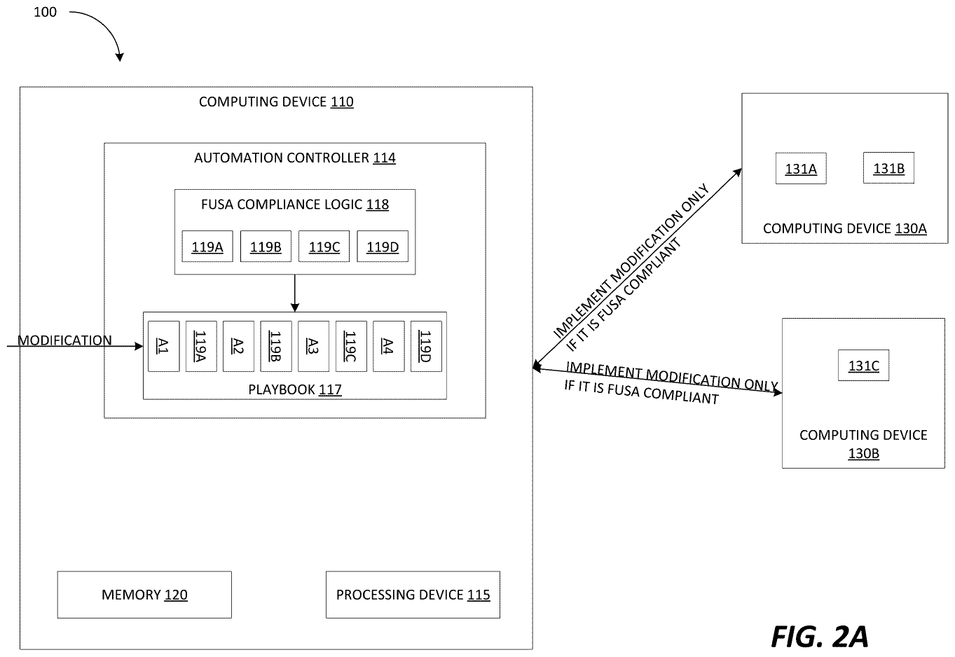

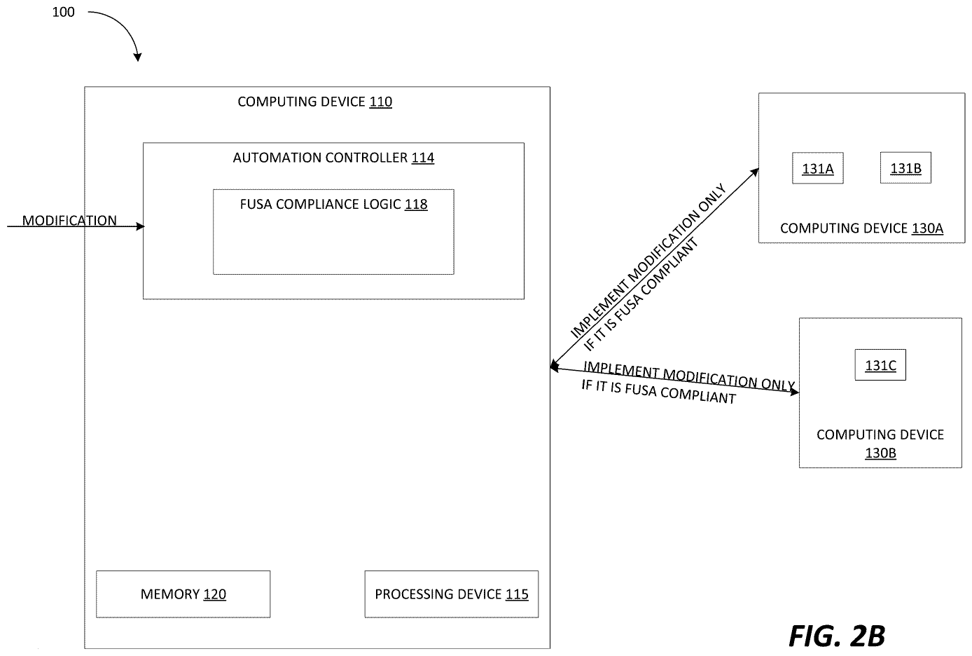

FIGS. 2A and 2B illustrate the automation controller 114 in accordance with some embodiments of the present disclosure. The automation controller 114 may include FUSA compliance logic 118 which may include a set of modules 119. Each module 119 may include logic corresponding to a FUSA rule. A FUSA rule (hereinafter referred to simply as “rule”) may be a rule that must be complied with in order for an application (e.g., application 131) to be (or remain) certified as FUSA compliant as discussed herein. Stated differently, each of the set of rules that an application 131 must comply with to be (or remain) certified as FUSA compliant may be translated into a corresponding module 119. In the examples described herein, the set of rules may be defined as part of the ISO 26262 standard which governs FUSA compliance in the automotive context. The set of rules may dictate requirements relating to application hardware (e.g., memory) access, inter-application communication, and encryption/security, among many others. The FUSA compliance logic 118 may also include logic to use the set of modules 119 to perform FUSA compliance verification on modifications that the automation controller 114 is to implement on the applications 131 as discussed in further detail herein. In this way, the compliance logic 118 may ensure that such modifications will not render the applications 131 they are implemented on as non-FUSA compliant.

As shown in FIG. 2A, the automation controller 114 may receive a modification to be implemented on each of the applications 131. The modification may be any appropriate modification such as a software update (e.g., patch) or a configuration change. The compliance logic 118 may analyze the modification using each of the set of modules 119 to determine if the modification is FUSA compliant (i.e., if any of the rules embodied in the set of modules 119 are violated by the modification). More specifically, the automation controller 114 may build a playbook 117 for implementing the modification, and may include each of a set of actions associated with implementing the modification (shown as actions A1-A4 in FIG. 2A) within the playbook 117. The automation controller 114 may also include in the playbook 117, the set of modules 119. For each action A1-A4, the automation controller 114 may identify the relevant rule from the set of rules that will ensure that the action is FUSA compliant. For each action A1-A4, the automation controller 114 may identify the module 119 that embodies the relevant rule as the module 119 corresponding to the action. As shown in FIG. 2A, when building the playbook 117, each action A1-A4 may have its corresponding module 119 “layered” thereon. When the automation controller 114 executes the playbook 117, the compliance logic 118 may compare each action A1-A4 to the rule of its corresponding module 119 to determine if it is FUSA compliant, and will not analyze a subsequent action until it has confirmed that a current action it is analyzing is FUSA compliant (i.e., meets the rule of its corresponding module 119). In this way, the compliance logic 118 may analyze the modification using each of the set of modules 119 sequentially to determine if the modification (i.e., each individual action thereof) is FUSA compliant.

If the compliance logic 118 determines that the modification (i.e., any particular action thereof) is FUSA non-compliant, it may stop execution of the playbook 117 to prevent the modification from being implemented. If the compliance logic 118 determines that the modification is FUSA compliant (i.e., all of the actions involved in the modification meet their respective rules), it may allow execution of the playbook 117 to finish, thereby implementing the modification. In some embodiments, the playbook 117 may be a playbook dedicated to performing the compliance analysis of the modification, while a separate playbook (not shown) may handle the actual implementation of the modification.

It should be noted that certain applications 131 may have their own set of rules they must comply with to be FUSA compliant that is different from the set of rules that other applications 131 must comply with to be FUSA compliant. Thus, in some embodiments, the compliance logic 118 may store one or more sets of modules (not shown) that are each specific to certain applications 131, although the examples herein are described with respect to a single set of rules/single set of modules 119 for ease of illustration and description. Variations in the rules that applications 131 must comply with may be application, device (e.g., computing device 130), or system (e.g., system 100) specific and embodiments of the present disclosure may account for these variations as well. Further, in some embodiments, the compliance logic 118 may host each module from the one or more sets of modules individually to provide compliance verification in a modularized manner. For example, if a particular modification is received for particular applications 131, the automation controller 114 may determine what rules must be complied with for those particular applications 131 to remain FUSA compliant and pull the modules corresponding to those rules into the playbook for implementing the particular modification. This modularity can be extended to sharing of modules among devices e.g., among computing devices 130. For example, while computing devices 130A and 130B may have different requirements for their respective applications 131 to be FUSA compliant, certain modules 119 may be common. Thus, if modules 119 B and 119C have been used recently for compliance verification of applications 131 on computing device 130A, they may be reused for compliance verification of applications 131 on computing device 130A.

Verification of a modification as FUSA compliant does not always ensure that the application 131 (e.g., application 131A) that the modification applies to will be operating in a FUSA compliant state. For example, a modification that has been verified as FUSA compliant by the automation controller 114 as described hereinabove may not be properly installed on the vehicle (i.e., computing device 130) e.g., because the vehicle's WiFi was switched off or the vehicle exited transmission range during transmission of the modification (resulting in only a portion of the modification being received by the vehicle). In another example, there may be certain vehicle-specific variables that may render as non-FUSA compliant, the application 131A that has previously been updated with a modification that was certified as FUSA compliant by the automation controller 114 and successfully installed on the vehicle. For example, a driver of the vehicle may upload software (e.g., from a USB drive) that interacts with the application 131A in such a way that it renders the application 131A non-FUSA compliant.

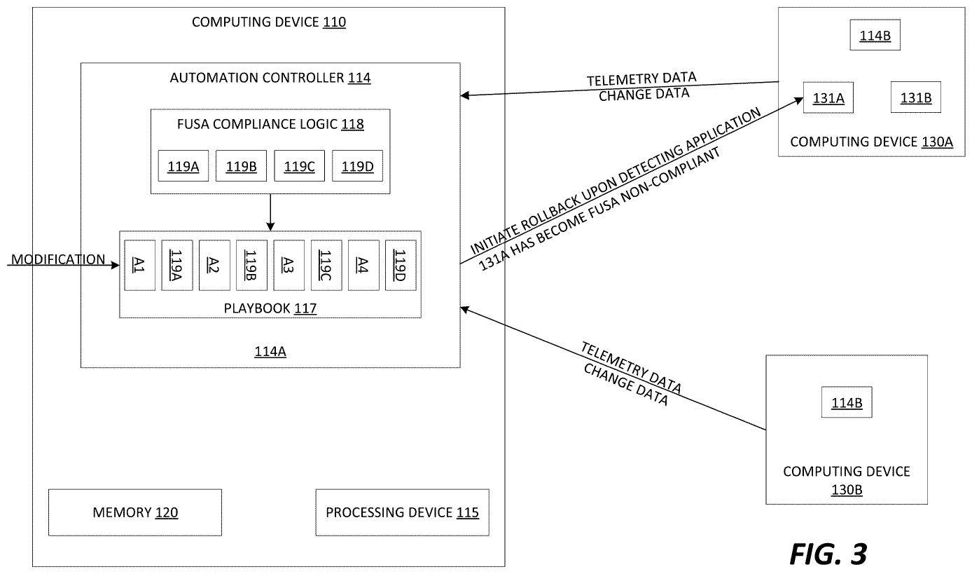

In such scenarios, the automation controller 114 may use a rollback capability to return the application 131A to a previous FUSA compliant state. FIG. 3 illustrates the system 100 when monitoring for applications 131 that have become non-FUSA compliant and returning such applications 131 to a previous FUSA compliant state. As shown in FIG. 3, the automation controller 114 may comprise an architecture that includes a control plane 114A (e.g., a web user interface (webUI) and application program interface (API)) and an execution plane 114B (e.g., command-line and playbook execution functionality) that runs on each vehicle. The execution plane 114B may include monitoring functionality which may monitor applications 131 on the respective vehicles for changes (referred to herein and shown in FIG. 3 as “change data”) that indicate that they are no longer FUSA compliant. Change data may include e.g., version changes of application dependencies or firmware version changes etc. Similarly, each application 131 may transmit e.g., telemetry data to the control plane 114A which may indicate that they are no longer FUSA compliant. Telemetry data may include data about the usage/availability of compute resources (e.g., CPU, RAM, I/O), application uptime, application response times, and other service related metadata that a traditional task manager would expose. The control plane 114 may utilize the change data from the execution plane 114B monitoring functionality and the telemetry data from each application 131 to identify when an application 131 has been modified in such a way that it has been rendered non-FUSA compliant.

In response to determining that an application 131 (e.g., application 131A) has been rendered non-FUSA compliant, the automation controller 114 may utilize a rollback mechanism to return the application 131A to a previous FUSA compliant state.

By shifting standards compliance mechanisms to an automation controller (i.e., configuration management system), embodiments of the present disclosure ensure the interoperability of the automation controller still adheres to the standards compliance requirements of a target application, device, or system. This allows a “write once run anywhere” approach to application standards compliance.

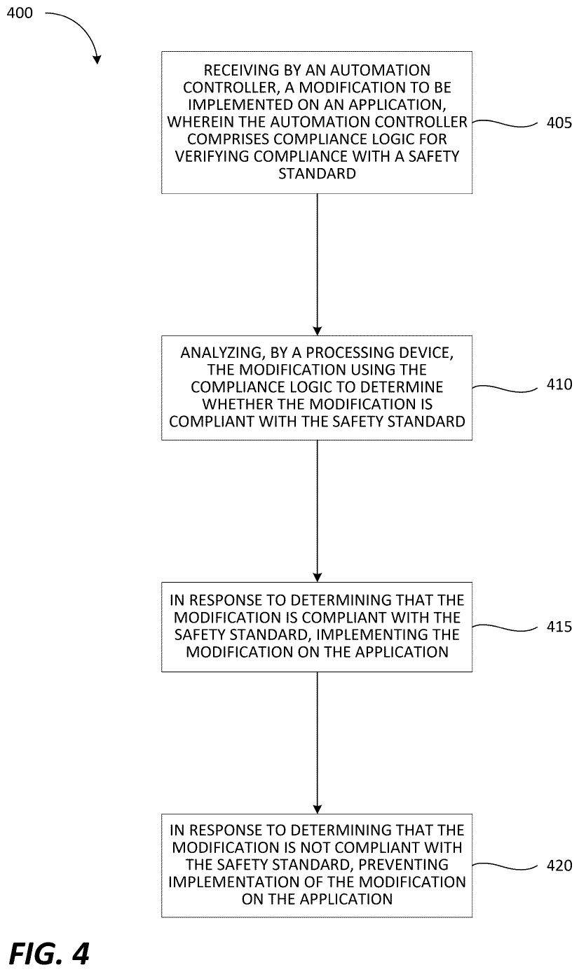

FIG. 4 is a flow diagram depicting a method 400 of analyzing modifications to be implemented on applications to determine whether such modifications will render the applications non-FUSA compliant. Method 400 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 400 may be performed by processing device 115 (executing the automation controller 114), as shown in FIGS. 2A, 2B, and 3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring also to FIGS. 2A, 2B and 3, at block 405 the automation controller 114 may receive a modification to be implemented on each of the applications 131. The modification may be any appropriate modification such as a software update (e.g., patch) or a configuration change. The automation controller 114 may include FUSA compliance logic 118 which may include a set of modules 119. Each module 119 may include logic corresponding to a FUSA rule. A FUSA rule (hereinafter referred to simply as “rule”) may be a rule that must be complied with in order for an application (e.g., application 131) to be (or remain) certified as FUSA compliant as discussed herein. Stated differently, each of the set of rules that an application 131 must comply with to be (or remain) certified as FUSA compliant may be translated into a corresponding module 119. In the examples described herein, the set of rules may be defined as part of the ISO 26262 standard which governs FUSA compliance in the automotive context. The set of rules may dictate requirements relating to application hardware (e.g., memory) access, inter-application communication, and encryption/security, among many others. The FUSA compliance logic 118 may also include logic to use the set of modules 119 to perform FUSA compliance verification on modifications that the automation controller 114 is to implement on the applications 131 as discussed in further detail herein. In this way, the compliance logic 118 may ensure that such modifications will not render the applications 131 they are implemented on as non-FUSA compliant.

At block 410, the compliance logic 118 may analyze the modification using each of the set of modules 119 to determine if the modification is FUSA compliant (i.e., if any of the rules embodied in the set of modules 119 are violated by the modification). More specifically, the automation controller 114 may build a playbook 117 for implementing the modification, and may include each of a set of actions associated with implementing the modification (shown as actions A1-A4 in FIG. 2A) within the playbook 117. The automation controller 114 may also include in the playbook 117, the set of modules 119. For each action A1-A4, the automation controller 114 may identify the relevant rule from the set of rules that will ensure that the action is FUSA compliant. For each action A1-A4, the automation controller 114 may identify the module 119 that embodies the relevant rule as the module 119 corresponding to the action. As shown in FIG. 2A, when building the playbook 117, each action A1-A4 may have its corresponding module 119 “layered” thereon. When the automation controller 114 executes the playbook 117, the compliance logic 118 may compare each action A1-A4 to the rule of its corresponding module 119 to determine if it is FUSA compliant, and will not analyze a subsequent action until it has confirmed that a current action it is analyzing is FUSA compliant (i.e., meets the rule of its corresponding module 119). In this way, the compliance logic 118 may analyze the modification using each of the set of modules 119 sequentially to determine if the modification (i.e., each individual action thereof) is FUSA compliant.

At block 415, if the compliance logic 118 determines that the modification is FUSA compliant (i.e., all of the actions involved in the modification meet their respective rules), it may allow execution of the playbook 117 to finish, thereby implementing the modification. At block 420, if the compliance logic 118 determines that the modification (i.e., any particular action thereof) is FUSA non-compliant, it may stop execution of the playbook 117 to prevent the modification from being implemented.

It should be noted that certain applications 131 may have their own set of rules they must comply with to be FUSA compliant that is different from the set of rules that other applications 131 must comply with to be FUSA compliant. Thus, in some embodiments, the compliance logic 118 may store one or more sets of modules (not shown) that are each specific to certain applications 131, although the examples herein are described with respect to a single set of rules/single set of modules 119 for ease of illustration and description. Variations in the rules that applications 131 must comply with may be application, device (e.g., computing device 130), or system (e.g., system 100) specific and embodiments of the present disclosure may account for these variations as well. Further, in some embodiments, the compliance logic 118 may host each module from the one or more sets of modules individually to provide compliance verification in a modularized manner. For example, if a particular modification is received for particular applications 131, the automation controller 114 may determine what rules must be complied with for those particular applications 131 to remain FUSA compliant and pull the modules corresponding to those rules into the playbook for implementing the particular modification. This modularity can be extended to sharing of modules among devices e.g., among computing devices 130. For example, while computing devices 130A and 130B may have different requirements for their respective applications 131 to be FUSA compliant, certain modules 119 may be common. Thus, if modules 119 B and 119C have been used recently for compliance verification of applications 131 on computing device 130A, they may be reused for compliance verification of applications 131 on computing device 130A.

Verification of a modification as FUSA compliant does not always ensure that the application 131 (e.g., application 131A) that the modification applies to will be operating in a FUSA compliant state. For example, a modification that has been verified as FUSA compliant by the automation controller 114 as described hereinabove may not be properly installed on the vehicle (i.e., computing device 130) e.g., because the vehicle's WiFi was switched off or the vehicle exited transmission range during transmission of the modification (resulting in only a portion of the modification being received by the vehicle). In another example, there may be certain vehicle-specific variables that may render as non-FUSA compliant, the application 131A that has previously been updated with a modification that was certified as FUSA compliant by the automation controller 114 and successfully installed on the vehicle. For example, a driver of the vehicle may upload software (e.g., from a USB drive) that interacts with the application 131A in such a way that it renders the application 131A non-FUSA compliant.

In such scenarios, the automation controller 114 may use a rollback capability to return the application 131A to a previous FUSA compliant state. FIG. 3 illustrates the system 100 when monitoring for applications 131 that have become non-FUSA compliant and returning such applications 131 to a previous FUSA compliant state. As shown in FIG. 3, the automation controller 114 may comprise an architecture that includes a control plane 114A (e.g., a webUI and API) and an execution plane 114B (e.g., command-line and playbook execution functionality) that runs on each vehicle. The execution plane 114B may include monitoring functionality which may monitor applications 131 on the respective vehicles for changes (referred to herein and shown in FIG. 3 as “change data”) that indicate that they are no longer FUSA compliant. Similarly, each application 131 may transmit e.g., telemetry data to the control plane 114A which may indicate that they are no longer FUSA compliant. The control plane 114 may utilize the change data from the execution plane 114B monitoring functionality and the telemetry data from each application 131 to identify when an application 131 has been modified in such a way that it has been rendered non-FUSA compliant. [

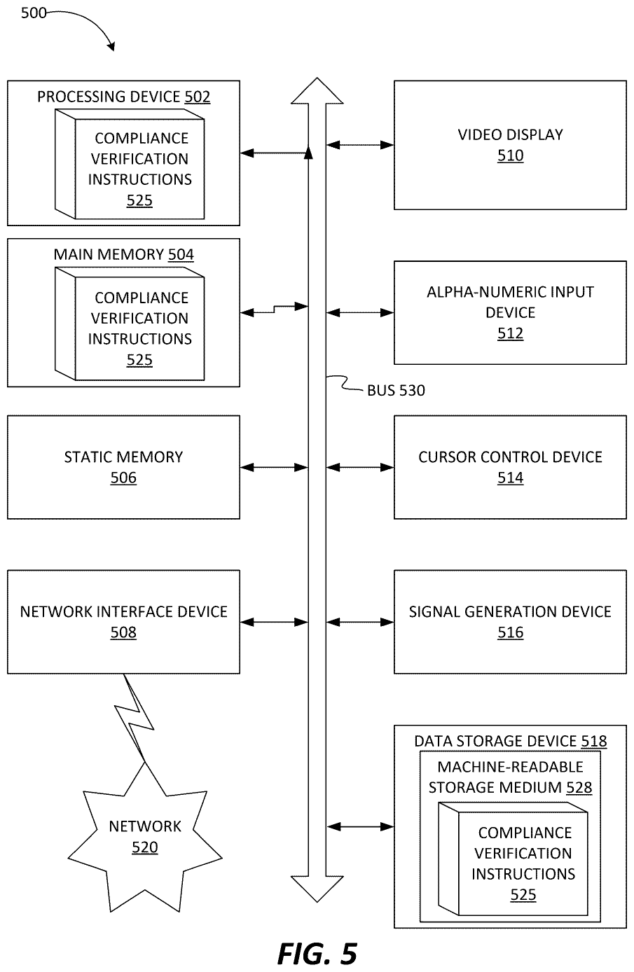

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of compliance verification instructions 525 that may include instructions for one or more components, agents, and/or functions (e.g., compliance plugin 126 in FIG. 3) for carrying out the operations described herein, in accordance with one or more aspects of the present disclosure. The compliance verification instructions 525 may also reside, completely or at least partially, within main memory 504 and/or within processing device 502 during execution thereof by computing device 500, main memory 504 and processing device 502 also constituting computer-readable media. The compliance verification instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “analyzing,” “preventing,” “implementing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving by an automation controller, a modification to be implemented on an application, wherein the automation controller comprises compliance logic for verifying compliance with a safety standard;
analyzing, by a processing device, the modification using the compliance logic to determine whether the modification is compliant with the safety standard;
in response to determining that the modification is compliant with the safety standard, implementing the modification on the application; and
in response to determining that the modification is not compliant with the safety standard, preventing implementation of the modification on the application.

2. The method of claim 1, wherein the compliance logic comprises a set of modules and wherein each module of the set of modules comprises logic corresponding to a rule of a set of rules the safety standard is comprised of.

3. The method of claim 2, further comprising:
building an automation script comprising:
a set of actions to implement the modification; and
for each of the set of actions, a corresponding module from the set of modules to determine whether the action is compliant with the safety standard.

4. The method of claim 3, wherein analyzing the modification using the compliance logic comprises:
executing the automation script to analyze each of the set of actions sequentially using the corresponding module of the set of modules.

5. The method of claim 3, wherein the set of modules is part of a plurality of modules and the automation controller hosts each of the plurality of modules individually, and wherein building the automation script comprises:
identifying each of the set of rules the safety standard is comprised of; and
for each of the set of rules, pulling the module comprising logic corresponding to the rule into the automation script.

6. The method of claim 1, further comprising:
monitoring the application to determine whether the application has become non-compliant with the safety standard;
in response to determining that the application has become non-compliant with the safety standard, performing a roll back operation on the application to return the application to a previous standards compliant state.

7. The method of claim 1, wherein the automation controller is an infrastructure as code (IaC) tool.

8. A system comprising:
a memory; and
a processing device operatively coupled to the memory, the processing device to:
receive by an automation controller, a modification to be implemented on an application, wherein the automation controller comprises compliance logic for verifying compliance with a safety standard;
analyze the modification using the compliance logic to determine whether the modification is compliant with the safety standard;
in response to determining that the modification is compliant with the safety standard, implement the modification on the application; and
in response to determining that the modification is not compliant with the safety standard, prevent implementation of the modification on the application.

9. The system of claim 8, wherein the compliance logic comprises a set of modules and wherein each module of the set of modules comprises logic corresponding to a rule of a set of rules the safety standard is comprised of.

10. The system of claim 9, wherein the processing device is further to:
build an automation script comprising:
a set of actions to implement the modification; and
for each of the set of actions, a corresponding module from the set of modules to determine whether the action is compliant with the safety standard.

11. The system of claim 10, wherein to analyze the modification using the compliance logic, the processing device is to:
execute the automation script to analyze each of the set of actions sequentially using the corresponding module of the set of modules.

12. The system of claim 10, wherein the set of modules is part of a plurality of modules and the automation controller hosts each of the plurality of modules individually, and wherein to build the automation script the processing device is to:
identify each of the set of rules the safety standard is comprised of; and
for each of the set of rules, pull the module comprising logic corresponding to the rule into the automation script.

13. The system of claim 8, wherein the processing device is further to:
monitor the application to determine whether the application has become non-compliant with the safety standard;
in response to determining that the application has become non-compliant with the safety standard, perform a roll back operation on the application to return the application to a previous standards compliant state.

14. The system of claim 8, wherein the automation controller is an infrastructure as code (IaC) tool.

15. A non-transitory computer-readable medium having instructions stored thereon which, when executed by a processing device, cause the processing device to:
receive by an automation controller, a modification to be implemented on an application, wherein the automation controller comprises compliance logic for verifying compliance with a safety standard;
analyze, by the processing device, the modification using the compliance logic to determine whether the modification is compliant with the safety standard;
in response to determining that the modification is compliant with the safety standard, implement the modification on the application; and
in response to determining that the modification is not compliant with the safety standard, prevent implementation of the modification on the application.

16. The non-transitory computer-readable medium of claim 15, wherein the compliance logic comprises a set of modules and wherein each module of the set of modules comprises logic corresponding to a rule of a set of rules the safety standard is comprised of.

17. The non-transitory computer-readable medium of claim 16, wherein the processing device is further to:
build an automation script comprising:
a set of actions to implement the modification; and
for each of the set of actions, a corresponding module from the set of modules to determine whether the action is compliant with the safety standard.

18. The non-transitory computer-readable medium of claim 17, wherein to analyze the modification using the compliance logic, the processing device is to:
execute the automation script to analyze each of the set of actions sequentially using the corresponding module of the set of modules.

19. The non-transitory computer-readable medium of claim 17, wherein the set of modules is part of a plurality of modules and the automation controller hosts each of the plurality of modules individually, and wherein to build the automation script the processing device is to:
identify each of the set of rules the safety standard is comprised of; and
for each of the set of rules, pull the module comprising logic corresponding to the rule into the automation script.

20. The non-transitory computer-readable medium of claim 15, wherein the processing device is further to:
monitor the application to determine whether the application has become non-compliant with the safety standard;
in response to determining that the application has become non-compliant with the safety standard, perform a roll back operation on the application to return the application to a previous standards compliant state.
